(19) United States
(12) Patent Application Publication
(10) Pub. No.: US 2016/0114303 A1
(43) Pub. Date: Apr. 28, 2016

(54) Halloysite Nanotubes and Uses Thereof for Novel Remediation Techniques

(71) Applicants: Vijay John, Destrehan, LA (US); Gary McPherson, New Orleans, LA (US); Ram B. Gupta, Glen Allen, VA (US)

(72) Inventors: Vijay John, Destrehan, LA (US); Gary McPherson, New Orleans, LA (US); Ram B. Gupta, Glen Allen, VA (US)

(21) Appl. No.: 14/921,591

(22) Filed: Oct. 23, 2015

Related U.S. Application Data
(60) Provisional application No. 62/068,108, filed on Oct. 24, 2014.

(51) Int. Cl. B01F 17/00; C02F 3/34

(52) U.S. Cl. CPC B01F 17/0007; C02F 3/343; C02F 2305/04; C02F 2101/32

(57) ABSTRACT

The creation of novel halloysite-based compositions is disclosed. In one embodiment, the hollow clay nanotubes of halloysite are loaded with nanoscale zerovalent iron particles. The resulting composition provides an effective manner of remediating chlorinated hydrocarbons. In another embodiment, the hollow clay nanotubes of halloysite are imbibed with dispersants such as DOSS and Tween 80 surfactants. The resulting composition stabilizes oil-in-water emulsions and subsequently releases the surfactants, thereby reducing interfacial tension significantly, which allows much smaller droplets to form and thus provides for more effective oil remediation.

### CROSS-REFERENCES TO RELATED APPLICATIONS

This application claims the benefit of provisional U.S. Application No. 62/018,626, for “Halloysite Clay Nanotubes and Uses Thereof for Remediation of Chlorinated Hydrocarbons,” filed Nov. 19, 2014, and of provisional U.S. Application No. 62/068,108, for “Interfacially-Active Halloysite Clay Nanotubes and Uses Thereof for Oil Spill Remediation,” filed Oct. 24, 2014.

### BACKGROUND OF THE INVENTION

This invention provides for novel uses of the halloysite compound, which has a tubular structure that may be loaded with various particles, such as zerovalent iron particles or surfactant chemicals. The physical attributes of halloysite make it a preferred compound for use in solving multiple environmental problems, including remediation of chlorinated hydrocarbons and oil.

### Remediation of Chlorinated Hydrocarbons

Remediation of contaminants in groundwater and soil is an active area of research in the environmental field. In brief, chlorinated hydrocarbons such as trichloroethylene (TCE) form a class of dense nonaqueous phase liquid (DNAPL) contaminants that are difficult to remediate. They have a density higher than water and settle deep into the sediment from which they gradually leach out into aquifers, causing long-term environmental pollution. Remediation of these contaminants is of utmost importance for the cleanup of contaminated sites.

In recent years, the reductive dehalogenation of such compounds using zerovalent iron (ZVI) represents a promising approach for remediation. The overall redox reaction, using TCE as an example, is one in which gaseous products, such as ethane, result from complete reduction. ZVI is attractive to the development of such remediation technologies because of its low cost and environmentally benign nature. Compared to more conventional treatment processes, the in-situ direct injection of reactive ZVI into the contaminated subsurface is a preferred method because it may more directly access and target the contaminants.

Nanoscale zero-valent iron particles (NZVI) have an increased surface area, which often results in higher remediation rates. More importantly, the colloidal nature of nanoiron indicates that these NZVI particles can be directly injected into contaminated sites for source depletion or, alternatively, be devised to construct permeable reaction barriers for efficient TCE remediation. For successful in-situ source depletion of pure phase TCE, it is believed to be best for injected NZVI particles to migrate through the saturated zone to reach the contaminant. Determining and utilizing a compound that may effectively directly inject the reactive ZVI into the contaminated subsurface is thus a problem in the art, as well as determining and utilizing a compound that works effectively with these NZVI particles, which can provide a more effective remediation process.

For example, U.S. Patent Application Publication No. 2011/0130575 A1 to Li et al. for “Synthesis of clay-templated subnano-sized zero valent iron (ZVI) particles, clays containing same, and use of both in contaminant treatments” discloses a synthesis of clay-templated subnano-scale ZVI particles. Specifically, the Li et al. publication discloses a clay comprising a 2:1 aluminosilicate clay having negative charge sites, the 2:1 aluminosilicate clay containing subnano-sized zero valent iron (ZVI) particles distributed on clay surfaces. In one embodiment, at least some or all of the particles have a cross-section of five angstroms or less. Methods of synthesizing and the novel clays and the clay-templated subnano-scale ZVI particles themselves are also described. Such novel products are useful in a variety of remediation applications, including for reduction and dechlorination reactions. However, the Li et al. publication is directed to the use of clay materials which contain two tetrahedral silicone oxide sheets sandwiched with an aluminum oxide octahedral sheet between them. This leads to flat sheets of clay, which may be useful in supporting ZVI, but is inefficient for the purposes of groundwater transport. In contrast, as is described more fully below, the instant invention discloses the use of halloysite, a 1:1 aluminosilicate clay material, and the creation of ZVI-infused halloysite nanotubes. Cylindrical particles of the correct dimensions can follow groundwater flow streamlines effectively and can thus move through groundwater following a spreading plume of contaminants. The dimensions of halloysite and functionalized halloysite are entirely appropriate for such transport, and constitute a tremendous advantage in the use of these materials for ground water remediation of chlorinated hydrocarbons. Thus, the use of these ZVI-infused halloysite nanotubes enables more efficient transport of the nanotubes through the subsurface environment, which in turn enables more efficient remediation of the contaminated groundwater. The Li et al. publication, because it only discloses the use of a 2:1 aluminosilicate clay, does not disclose any use of halloysite or of the concept of particle transport through the subsurface environment.

At particle sizes exceeding 15 nm, ZVI exhibits ferromagnetism, leading to particle aggregation and a loss in mobility. The particles by themselves are therefore inherently ineffective for in-situ source depletion as they form large aggregates that do not move through groundwater saturated sediments. It is therefore necessary to immobilize ZVI onto supports to prevent aggregation, and this invention in particular relates to the immobilization of ZVI particles onto halloysite nanotubes. Prior art has determined that the transport of colloidal particles through porous media is determined by competitive mechanisms of diffusive transport, interception by soil or sediment grains, and sedimentation effects as shown through the now-classical theories of colloid transport. The Tufenkji-Elimelch model, which considers the effect of hydrodynamic forces and van der Waals interactions between the colloidal particles and soil/sediment grains, is a significant advance in modeling transport of colloidal particles through sediment, and predicts optimal particle sizes between 200 nm-1000 nm for ZVI particles at typical groundwater flow conditions.

One of the common methods to increase nanoiron mobility is to stabilize the particles by adsorption of organic molecules on the particle surface. The adsorbed molecules enhance steric or electrostatic repulsions between particles to prevent their aggregation. Techniques include the use of polymers, surfactants, starch, modified cellulose, and vegetable oils as stabilizing layers to form more stable dispersions. These methods enhance steric or electrostatic repulsions of particles to prevent their aggregation and may be effective if the physically adsorbed stabilizers are retained during particle migration through sediments. However, coating the zerovalent iron nanoparticles with polymers, as is performed in conventional technology, is cost-prohibitive and may not be environmentally benign. The use of biodegradable polymers and proteins as coatings has also been performed in the art, but it is unknown whether these coatings will survive transport through sediments. Functionalization of ZVI nanoparticles with organic ligands is another alternative, but such functionalization is difficult and current research is unclear if the reactivity of ZVI is retained. There is thus also a need in the art for a more effective method of stabilizing the nanoiron particles, which increases the nanoiron mobility and leads to more effective remediation of chlorinated hydrocarbons.

### Remediation of Oil

Oil spills are often major occupational, environmental, and community health disasters. Crude oil spills can adversely affect the health of plants and animals in the ecosystem if adequate spill remediation procedures are not deployed. Oil spills are often treated by the addition of surface-active materials or dispersants, which disperse spill oils into tiny droplets.

Such surface-active materials, such as dispersants and lipophilic fertilizers, can facilitate the biodegradation process at the oil-water interface. Typical oil spill dispersants are a blend of surfactants with organic solvents, such as glycol and light petroleum distillates. Conventionally, the dispersant is sprayed onto the spill oils to break them into tiny droplets suspended in the water column. Such an application of dispersants can reduce the possibility of shoreline impact of oil, lessen the impact on birds and mammals, and promote the biodegradation of oil. For context, approximately 2.1 million gallons of dispersant was applied during the Deepwater Horizon Oil Spill. Deployment of the dispersant on such a macro scale may take the form of spraying the oil phase on the surface of a body of water with the composition, or through direct injection to an oil phase under the surface of a body of water. Ultimately, the surfactants, which are the active ingredients in existing dispersants, diffuse to the oil/water interface and reduce the oil-water interfacial tension, which allows the oil to mix into the water column as tiny droplets.

There are concerns over the potential impact of existing dispersants on the ecosystem. One of the key areas of concern is the volume of dispersants and hydrocarbon solvents introduced into the marine ecosystem. The solubility and miscibility of dispersant components coupled with the ocean waves often make it imperative to apply large amounts of the dispersant, which may lead to significant economic and environmental consequences. There is a thus a need in the art for development of environmentally benign dispersants. Moreover, a dispersant that features a more efficient delivery method can minimize the use of organic solvents. One method of remediating oil spills is through the use of emulsions, which are a dispersion of one liquid in another immiscible liquid in the form of small droplets, typically stabilized by the addition of emulsifiers. Oil slicks that are broken up into small emulsion droplets can be dispersed into the water column and thus mitigate the hazards associated with surface slicks approaching fragile coastlines and impacting the marine ecology and coastline ecology. Additionally, small oil droplets can be more easily degraded by microorganisms in comparison to surface slicks due to their much higher surface area. Breaking oil slicks into emulsion droplets requires the use of emulsifiers. While such emulsifiers are typically surfactants, it is known that interfacially-active solid particles can function as emulsifiers for stabilizing oil-in-water emulsions, and preventing droplet coalescence that will lead to the reformation of a surface slick. Several experimental and theoretical studies have been carried out on solids-stabilized emulsions to understand the factors that affect stability and the structure of the interface. The synergy of particles and surfactants in stabilizing emulsions has also been exploited in designing optimally stable emulsions in food and material science applications.

U.S. Pat. No. 6,401,816 issued on Jun. 11, 2002 to Price et al. for “Efficient Method for Subsurface Treatments, Including Squeeze Treatments.” The '816 patent discloses a method for delivering encapsulated materials to a subsurface environment, for the treatment of the subsurface environment, having the steps of: (1) loading the lumen of hollow microtubules with an active agent selected for treating the subsurface environment, where the hollow microtubules are compatible with the subsurface environment; and (2) administering the hollow microtubules to the subsurface environment, permitting the controlled release of the active agent into the subsurface environment. This method may be practiced using a slurry of hollow microtubules, where the lumen of these microtubules is loaded with an agent for the treatment of petroleum well environments, and where these loaded microtubules are dispersed in a liquid phase carrier selected from aqueous carriers, non-aqueous carriers, and emulsions of aqueous and non-aqueous materials. The disclosed method may also be practiced using a pill made of a consolidated mass of tubules loaded with one or more active agents, typically bound with a binder. The '816 patent, however, does not disclose the method of creating the surfactant-loaded halloysite of the instant invention, nor the methods of stabilizing the oil-in-water emulsions disclosed herein. Further, the '816 patent is directed to a method of pumping the tubules into a landmass subsurface environment for treatment of the oil, rather than administering a composition to an oil phase on the surface of a body of water. The current invention clearly relates to the ability of halloysite to (a) deliver surfactants to the oil water interface to lower the interfacial tension and break up the oil into small droplets that can be dispersed into the water column, and (b) stabilize the oil water interface to prevent coalescence of oil droplets that will lead to reformation of an oil slick.

### SUMMARY OF THE INVENTION

The use of halloysite as a base compound provides an environmentally benign solution to the above remediation problems. Halloysite is a naturally occurring 1:1 aluminosilicate with the chemical formula Al₂[Si₂O₅(OH)₄]*2H₂O. It is formed from the rolling of kaolinite sheets into tubes due to the lateral misfit of the smaller gibbsitic octahedral sheet and the larger silica tetrahedral sheet. In each halloysite nanotube, the external surface is negatively charged and consists of siloxane (Si—O—Si) groups, while the internal surface is positively charged and consists of the aluminol (Al—OH) groups. Because the halloysite possesses a predominately negatively charged outer silica surface and a positively charged inner alumina surface at the pH of the subsurface environment, it has a cation-exchange capacity. Another useful aspect of halloysite for purposes of the instant remediation problems is its tubular scroll-like structure, which allows for encapsulation of materials.

Prior art has noted the advantages of halloysite in various research areas, such as those disclosed in U.S. Patent Application Publication No. 2009/0005489 A1 to Daly et al. for “Nanoclay Filled Fluoropolymer Dispersions and Method of Forming Same,” published Jan. 1, 2009. The Daly et al. publication discloses an aqueous dispersion and a method for making said dispersion, and more particularly, a dispersion that comprises a nanoclay such as a tubular clay (e.g., halloysite), a fluoropolymer, and the requisite surfactants for dispersion stability. In various embodiments, and applications thereof to substrates and the like, the dispersion improves the manufacturability of articles that include coating fluoropolymer dispersions while retaining the unique properties of the fluoropolymer coating. The Daly et al. publication, however, only discloses the use of halloysite in conjunction with fluoropolymer, which is then used as a coating or part of a composition with use in architectural fabrics, membranes, wire insulation, and similar protective coatings.

Regarding the remediation of chlorinated hydrocarbons, the halloysite nanotubes have the ability to support ZVI nanoparticles on both the internal and external surfaces. The use of the halloysite nanotubes is a novel approach to the preparation of the ZVI nanoparticles, which may then be efficiently and effectively transported to contaminant sites. The surfactant-loaded halloysite functions effectively as an adsorbent for TCE. The halloysite nanotubes are easily functionalized with alkyl groups, and the resulting composites have multiple characteristics that solve the problems presented by remediation of chlorinated hydrocarbons. First, they are in the optimal size range for transport through sediments. Second, dissolved TCE adsorbs to the hydrophobic alkyl groups of the surfactants and/or polymers, thereby bringing tremendously increasing contaminant concentration near the ZVI sites. Third, they are reactive, as access to the ZVI particles is possible. Fourth, when they reach bulk TCE sites, the alkyl groups extend out to stabilize the particles in the TCE bulk phase, or at the water-TCE interface. Fifth, and crucially in this area of research, the materials are environmentally benign.

Regarding the remediation of oil, a novel formation of halloysite may be used to stabilize oil-in-water emulsions. The pore volume in the tubules can sequester surfactants, thereby allowing a release of surfactant to the oil-water interface. It is known in the art that halloysite may be used in the controlled release of pharmaceutical and agricultural compounds and in the fabrication of composite polymer microparticles via suspension and emulsion-based routes for drug-delivery application. However, the present invention discloses a method of functionalizing the surface of halloysite, by 1) inserting surfactant into the tubular voids of the halloysite for a novel use in stabilizing emulsions and 2) attaching polymers to the halloysite nanotubes to create steric barriers to aggregation of the nanotubes and to promote colloidal stability, as well as a novel delivery of surfactants to the oil-water interface and a novel application to oil spill remediation. The functionalized halloysite stabilizes oil-in-water emulsions and subsequently releases the surfactants, thereby reducing the interfacial tension significantly, which allows much smaller droplets to form. It may be appreciated by those in the art that this use leads to enhanced dispersion and degradation of the oil spill.

### BRIEF DESCRIPTION OF THE DRAWINGS

FIG. 1 represents a methodology of creating NZVI-loaded halloysite nanotubes according to one embodiment of the present invention;

FIG. 2 represents an alternate methodology of creating NZVI-loaded halloysite nanotubes according to an alternate embodiment of the present invention;

FIG. 3 represents a depiction of NZVI-loaded halloysite nanotubes;

FIG. 4 represents an analysis of the normalized turbidity of halloysite when used in combination with a CMC solution;

FIG. 5 represents a methodology of creating surfactant-loaded halloysite nanotubes according to one embodiment of the present invention;

FIG. 6 represents a methodology of oil remediation with use of the surfactant-loaded halloysite nanotubes as created in FIG. 5;

FIG. 7 represents an analysis of surfactant into saline water as disclosed by the present invention;

FIG. 8 represents an analysis of the measurement of the oil-water interfacial tension in the presence of the surfactant-loaded halloysite nanotubes of the present invention;

FIG. 9 represents the hollow nanotubular structure of the native halloysite particle with an empty lumen, as disclosed by the present invention;

FIG. 10 represents an analysis of the higher electron density created from filling the lumen with surfactant, as disclosed by the present invention;

FIG. 11 represents an analysis of the TGA curves for halloysite and a surfactant-loaded halloysite, as disclosed by the present invention;

FIG. 12 represents an analysis of the kinetics of release for surfactants DOSS and Tween 80 from halloysite nanotubes into saline water, as disclosed by the present invention;

FIG. 13 represents an analysis of the synergistic emulsion stabilization by halloysite nanotubes and the DOSS surfactant, as disclosed by the present invention;

FIG. 14 represents an analysis of the release of surfactant molecules from halloysite nanotubes into the dodecane phase, as disclosed by the present invention;

FIG. 15 represents an analysis of the combined effects of the three surfactants used in the formulation of COREXIT 9500, as disclosed by the present invention; and

FIG. 16 represents an analysis of an optical micrograph of crude oil-in-saline water emulsion, stabilized by halloysite nanotubes loaded with a ternary mixture of DOSS, Tween 80, and Span 80, as disclosed by the present invention.

### DETAILED DESCRIPTION OF THE DRAWINGS

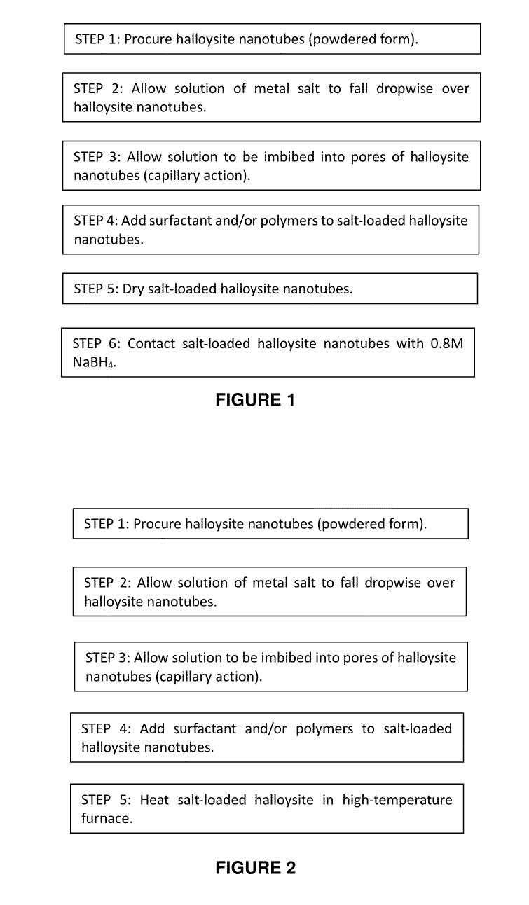

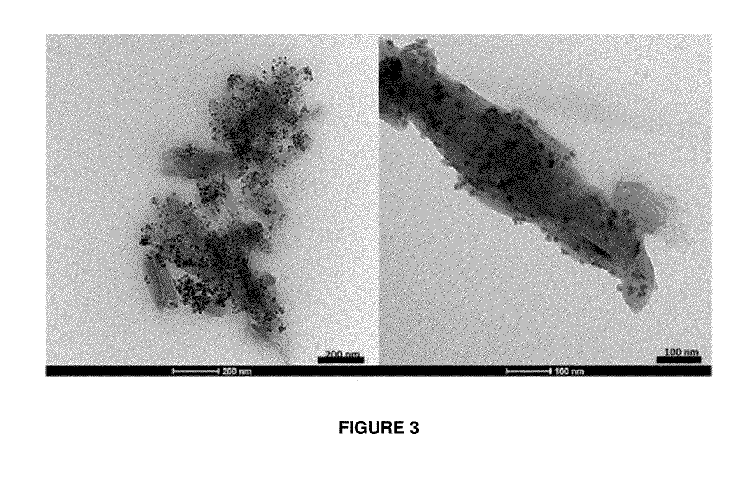

FIG. 1 outlines the methodology of the creation of one embodiment of the invention, in which novel halloysite nanotubes act as carriers for zerovalent iron in the remediation of chlorinated compounds. As depicted in FIG. 3, NZVI particles may be placed in the pores of the halloysite nanotubes, within the inner lumens of the halloysite nanotubes via capillary action, between the curled sheets of the halloysite nanotubes, and on the outer surface of the halloysite nanotubes.

In some embodiments, the NZVI particles are placed in the halloysite by imbibing a metal salt (for example, FeCl₃ or FeSO₄) into the pores of halloysite, drying up the metal salt-loaded halloysite nanotubes. The metal salt-loaded halloysite nanotubes are then contacted with sodium borohydride (NaBH₄) to transform the iron species into zerovalent iron.

First, as shown in Step 1 of FIG. 1, halloysite nanotubes in powdered form are procured. Second, as shown in Step 2 of FIG. 1, a solution of metal salt (for example, FeCl₄ or FeSO₄) is allowed to fall dropwise over the halloysite nanotubes. Third, as shown in Step 3 of FIG. 1, the capillary action allows the solution to be imbibed into the pores of the halloysite nanotubes. Fourth, as shown in Step 4 of FIG. 1, the salt-loaded halloysite nanotubes are dried completely by means known in the art. Last, as shown in Step 5 of FIG. 1, the salt-loaded halloysite nanotubes are contacted with 0.8M NaBH₄, sufficient to react all of the iron species within the halloysite nanotubes into NZVI, or until H₂ evolution stops indicating reduction is complete.

In another embodiment, as depicted in FIG. 2, the NZVI particles are placed in the halloysite nanotubes by imbibing a metal salt (such as FeCl₃ or FeSO₄) into the pores of the halloysite nanotubes. As shown in Step 1 of FIG. 2, the iron salt-loaded halloysite nanotubes are heated in a high temperature furnace, at 500° C., under a hydrogen atmosphere or a mixed hydrogen/nitrogen atmosphere for three hours. As shown in Step 2 of FIG. 2, the heating transforms the iron species loaded within the halloysite nanotubes to NZVI particles.

The NZVI-loaded halloysite nanotubes, as created by the method disclosed above, provides a novel decontamination system containing halloysite nanotubes in the optimal size range for transport through the soil. The halloysite nanotubes are preferably enveloped in a polyelectrolyte (carboxymethyl cellulose, CMC), to which a bimetallic nanoparticle system of zerovalent iron and palladium (Pd) is preferably attached. Platinum (Pt), gold (Au), and nickel (Ni) may also be used instead of palladium. It may be appreciated that nickel is the least expensive material, while palladium is the most effective for this application, but nickel is close to palladium in efficacy. A range of transition metals may also be used.

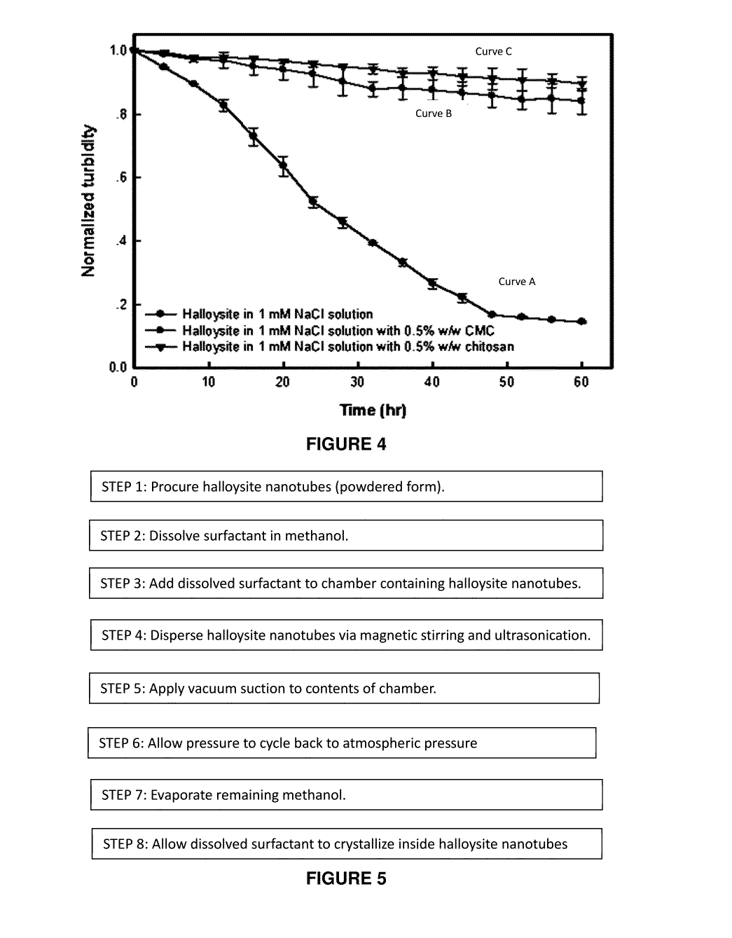

CMC, the polyelectrolyte, is a widely used additive for colloidal stabilization through both steric and electrostatic repulsion effects. When being dissolved in water, CMC has the tendency to bind to the inner surface of the halloysite, since this inner surface is positively charged. After the CMC is used, these positive charges on the internal surface of the halloysite are neutralized. It may be appreciated by those in the art that the adsorption of CMC into the halloysite lumen thus increases the net negative charge of the halloysite, which enhances the electrostatic repulsions between particles and consequently the dispersion stability. As shown by Curve C in FIG. 4, the use of CMC to increase the net negative charge of the halloysite leads to dramatically more stable turbidity over the course of several days. For reference, the data depicted in FIG. 4 represents sedimentation curves of halloysite in 0.5% (w/w) CMC solution, 0.5% (w/w) Chitosan solution and water. One mM NaCl was added as the electrolyte. The normalized turbidity is defined as the ratio of real-time turbidity to the initial turbidity of the colloidal suspensions.

The halloysite nanotubes serve as a strong adsorbent to TCE, while the system of bimetallic nanoparticles provide the reactivity necessary to remediate the chlorinated hydrocarbons. The polyelectrolyte serves to stabilize the halloysite nanotubes in aqueous solution. In contact with bulk TCE, there is a sharp partitioning of the system to the TCE side of the interface, due to the hydrophobicity of the core. These multifunctional systems appear to satisfy criteria related to remediation, and are relatively inexpensive and made with potentially environmentally benign materials, solving multiple problems encountered in remediation of chlorinated hydrocarbons.

Turning now to FIGS. 5-16, FIG. 5 depicts an embodiment of the present invention of the methodology of loading halloysite nanotubes with surfactants. First, 0.2 g of halloysite nanotubes, which may be obtained from a manufacturer such as NaturalNano. Inc., are weighed into a round bottom flask. A known amount of surfactant (such as DOSS, Tween 80, or Span 80), dissolved in methanol, is then added to the flask containing the halloysite nanotubes. The halloysite nanotubes are then dispersed by magnetic stirring and brief ultrasonication, performed for example on a Coleparmer 8890 machine. Vacuum suction is then applied to the contents of the flask to displace the air in the halloysite nanotubes and suck the surfactant solution into the halloysite nanotubes. The pressure is then cycled back to atmospheric pressure, typically after fifteen minutes. This cycling process is repeated two times. The remaining methanol is then allowed to evaporate under vacuum in a rotary evaporator to allow the loaded surfactant to crystallize inside the halloysite nanotubes. The result is surfactant-loaded halloysite nanotubes, which may be used for oil remediation as discussed above.

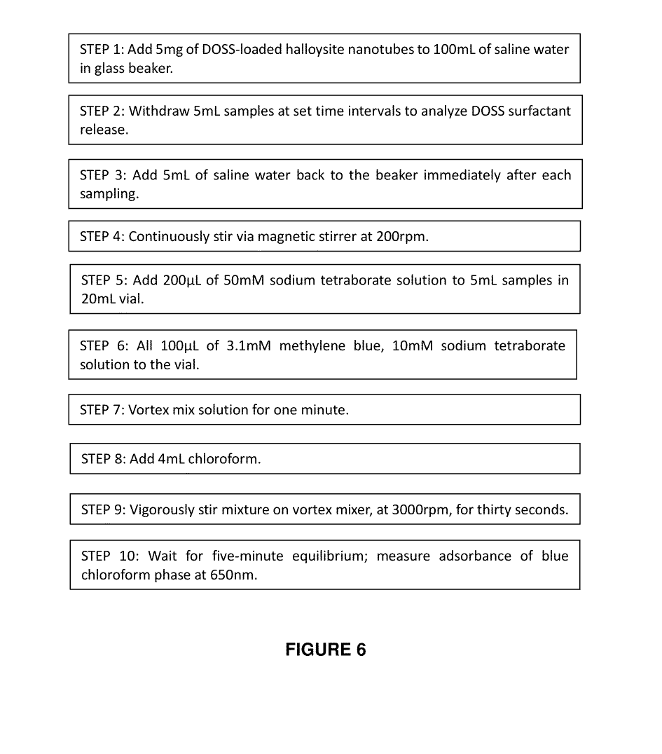

A method of oil remediation with use of these surfactant-loaded halloysite nanotubes is also disclosed, and depicted in FIG. 6. In one method, working on a relatively small scale, 5 mg of DOSS-loaded halloysite nanotubes may be added to 100 mL of saline water in a glass beaker. The DOSS loading, as determined by known thermogravimetric analysis methods, may be approximately 12.4 wt % in such a procedure. Five mL samples may then be withdrawn at several time intervals and analyzed for the DOSS surfactant release. Five mL of saline water may then be added back to the beaker immediately after each sampling to replace the saline water that was withdrawn. The system may be continuously stirred at 200 rpm, using a magnetic stirrer. The release kinetics of the DOSS surfactant into the saline water may be characterized by the simplified methylene blue active substances (MBAS) spectrophotometric method. Briefly, 200 μL of a 50 mM sodium tetraborate solution, at pH 10.5, is added to the 5 mL samples, in a 20 mL vial. One hundred μL of a solution containing 3.1 mM methylene blue and 10 mM sodium tetraborate is then added to the vial, followed by vortex mixing for one minute. Four mL of cholorform is then added, and the system is vigorously stirred on a vortex mixer at 3000 rpm for thirty seconds. After equilibrium for five minutes, the absorbance of the blue chloroform phase resulting from the transfer of the DOSS-methylene blue (DOSS-MB) complex may then be measured at 650 nm against air using a spectrophotometer.

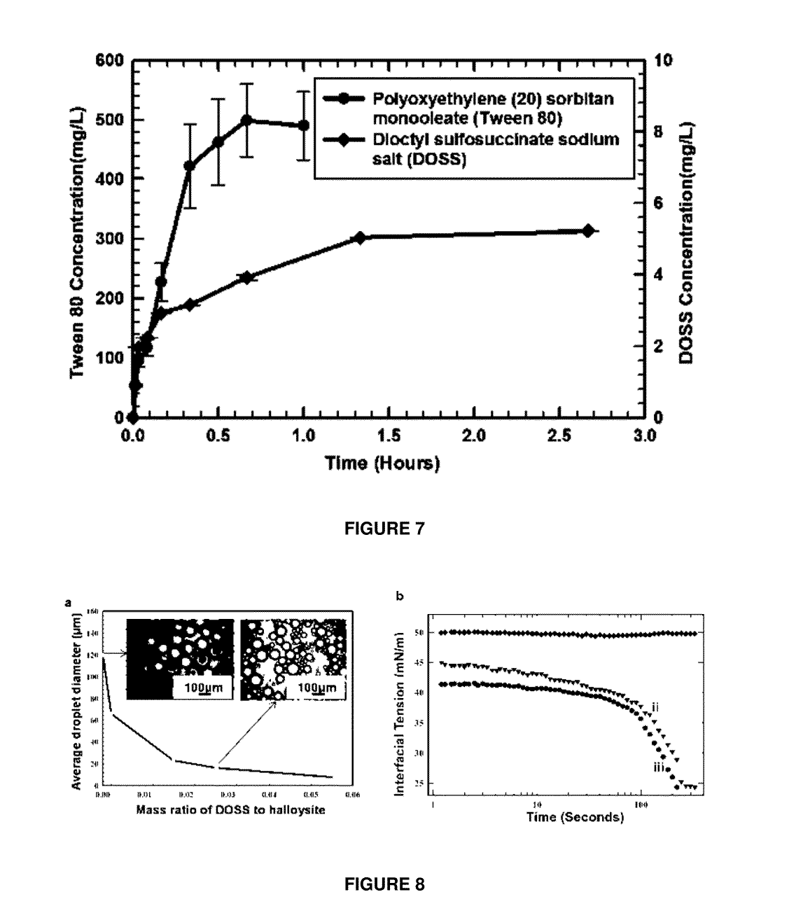

An analysis of the release of the Tween 80 surfactant into saline water is also disclosed, and as represented in FIG. 7, may be characterized by UV-spectroscopy using the cobalt thiocyanate active substances (CTAS) method. The CTAS reagent may be prepared by dissolving 3 g of Co(NO₃)₂ and 20 g of NH₄SCN in 100 mL of water. Five hundred mg of Tween 80-loaded halloysite nanotubes may be added into 100 mL of saline water and continuously stirred at 200 rpm. The Tween 80 loading, as determined by known thermogravimetric analysis methods, may be approximately 13.0 wt % in such a procedure. Samples of 0.75 mL may be withdrawn at intervals of time, and 0.75 mL of the CTAS reagent and 3 mL of chloroform may then be added to the samples, followed by vortex mixing at 3000 rpm for one minute. Absorbance of the chloroform phase containing the cobalt thiocyanate-polyethoxylate complex may then be measured at 620 nm. The amount of surfactant released over time may then be extracted from calibration curves prepared using known concentrations of the surfactants in saline water.

The measurement of the oil-water interfacial tension in the presence of the surfactant-loaded halloysite nanotubes is also disclosed and depicted in FIG. 8. The dynamic reduction in the dodecane-saline water interfacial tension may be measured by the pendant drop method using a standard goniometer (for example, Ramé-Hart, model 250). Five mg of the surfactant-loaded halloysite nanotubes may be weighed into 4 mL of dodecane in a glass cell. A drop of water of about 15 μL may then be quickly injected from a syringe. The dynamic interfacial tension may be measured by drop shape analysis using the DROPimage Advanced Software. Low crude oil-sale water interfacial tensions obtainable with surfactant-loaded halloysite dispersants may be measured using the spinning drop tensiometer (for example, Grace Instruments, model M6500). The spinning drop tensiometer has a rotating capillary of 2 mm inner diameter, with total volume of 0.282 cm. The surfactant-loaded halloysite nanotubes may be thoroughly mixed with crude oil by vortex mixing and sonication at various dispersant-to-oil-mass ratios. A small drop, of approximately 0.0005 cm, of the dispersant-oil mixture may be injected into the capillary, filled with saline water using a micro syringe. The capillary tube may then be sealed and rotated at a velocity in the range of 5000-6000 rpm. The temperature of the tube may be maintained at 25° C. by circulating cold water around the capillary tube. The radius of the oil drop may be measuring using an optical microscope fitted with a digital output, and the interfacial tension values calculated by Vonnegut's formula, known in the art. By use of the above technique, it may be determined that increasing the concentration of the halloysite nanotubes leads to dodecane-in-water emulsions with progressively smaller droplet sizes. It may be noted that there may be no significant reduction in droplet size beyond 0.5 wt % halloysite nanotube concentration. This effect of increasing halloysite nanotube concentration on the stability of the oil-in-water emulsions may be characterized by known centrifugation techniques. By such centrifugal validation, it may be shown that there is a significant impact of increasing halloysite concentration on emulsion stability and average droplet sizes between halloysite concentrations of 0.05 wt % and 0.5 wt %. The average droplet size, for example, may decrease by 53% and the fraction of oil resolved may decrease from 38% to 0% for the ten-fold increase in particle concentration from 0.05 wt % to 0.5 wt %.

It may be appreciated from the foregoing that the increased adsorption of halloysite nanotubes at higher concentrations leads to the formation of more stable emulsions. The formation of a rigid and protective interfacial film by the adsorption of the halloysite nanotubes at the oil-water interface provides steric hindrance to drop coalescence, leading to the high emulsion stability.

In practical oil spill remediation applications, the reduction in interfacial tension will aid the dispersion of spill oils into small droplets. This will expose a large oil-seawater interfacial area for the effective bioremediation of oil spills by indigenous bacteria in the ocean. Surfactants and interfacially-active particles can act synergistically to stabilize the emulsion. The adsorption of surfactant molecules at the interface serves to lower the interfacial tension while the adsorption of particles provides a steric barrier to drop coalescence. To demonstrate such a point, halloysite nanotubes may be loaded with surfactants by vacuum suction and solvent evaporation, as depicted by the methodology of FIG. 5.

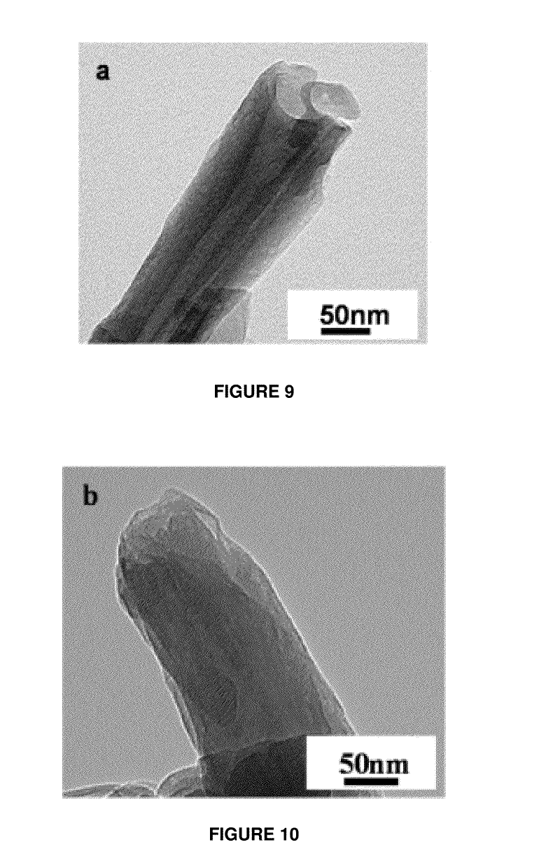

A comparison of TEM images and thermogravimetric curves for native halloysite nanotubes and surfactant-loaded halloysite nanotubes (for example, DOSS-loaded halloysite nanotubes) is also disclosed. FIG. 9 reveals the hollow nanotubular structure of the native halloysite clay particle with an empty lumen. The characteristic dimensions of the halloysite nanotubes may range from approximately 0.33 μm-1.5 μm in length, 90 nm-250 nm in external diameter, and 10 nm-70 nm in lumen. Loading of the surfactant (using, for example, DOSS as the surfactant), fills the lumen with surfactant and results in a higher electron density from the TEM imaging, as depicted in FIG. 10.

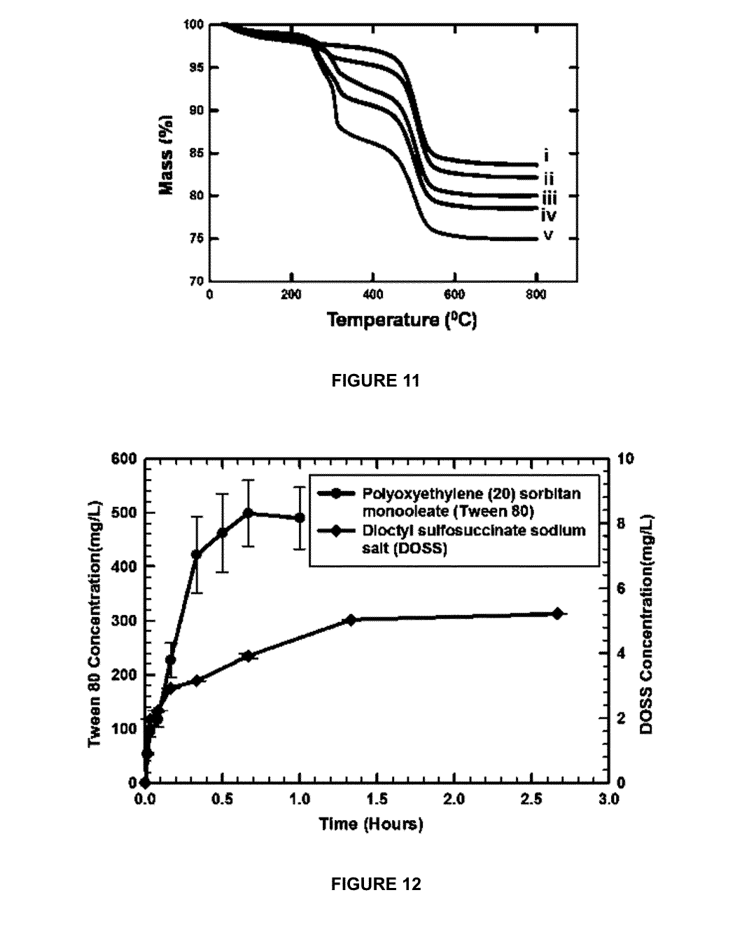

The TGA curves for halloysite and a surfactant-loaded halloysite at various surfactant loadings are depicted in FIG. 11. It may be appreciated that the TGA curve for native halloysite shows two distinct mass loses, centered at 64° C. and 510° C., respectively. The first mass loss, it may be appreciated, is due to the loss of water molecules adsorbed on the external surface of halloysite nanotubes, which the second mass loss is centered to the dehydroxilation of halloysite. The TGA curve for surfactant-loaded halloysite nanotubes of FIG. 11 has an additional distinct mass loss centered at 300° C. due to the thermal degradation of the loaded surfactant. The degree of mass loss increases accordingly with the amount of surfactant loaded into the halloysite nanotubes, as shown in curves A and B of FIG. 11.

The determination of the kinetics of release for surfactants DOSS and Tween 80 from halloysite nanotubes into saline water is also disclosed, and depicted in FIG. 12. Based on TGA analysis and mass balance calculations on the surfactant-loaded halloysite nanotube samples approximately 80% of the surfactant cargoes were typically released from the halloysite nanotubes over the relevant time period. It may be noted that the kinetics of release for Tween 80 are significantly higher than for DOSS, due to the higher water solubility of Tween 80. Use of the DOSS surfactant, an initial burst release over the first five minutes, due to the surface adsorption, may be followed by a much slower release as the sparingly water soluble surfactant slowly partitions out of halloysite into the aqueous phase. Electrostatic interactions between the anionic surfactant DOSS and the positively charged inner surface of the halloysite nanotube lumen may also contribute to the more sustained release of DOSS as compared to the non-ionic surfactant Tween 80.

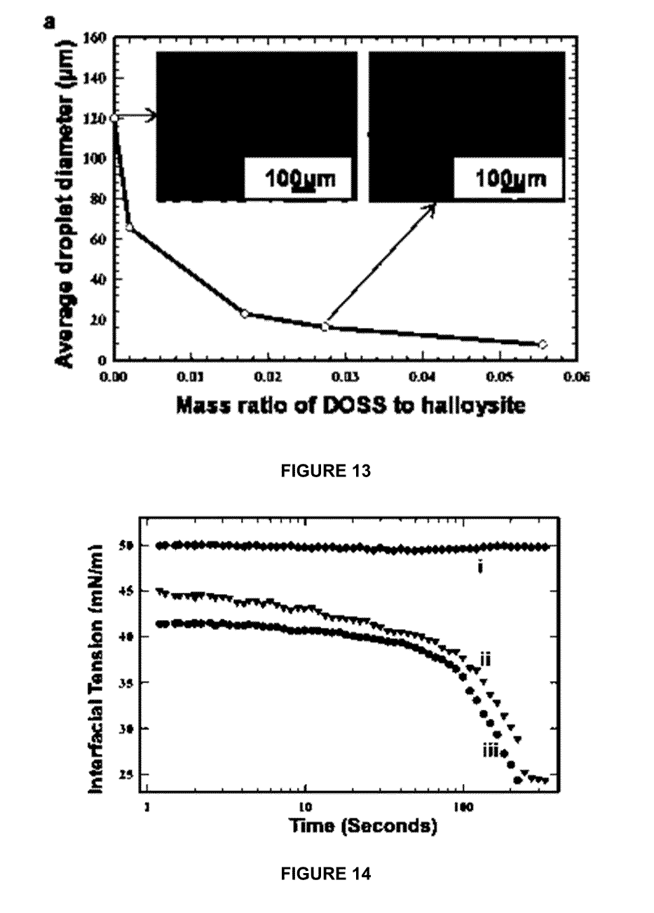

The determination of the effect of synergistic emulsion stabilization by halloysite nanotubes and DOSS is also disclosed, as depicted in FIG. 13. At constant halloysite concentration, the average droplet size decreases with increasing surfactant loading and release from halloysite nanotubes. It may be determined via known mathematical operations that reduction of the interfacial tension allows a significantly greater surface area generation (that is, smaller droplets) for the same work done to the system.

The interfacial tension dynamics when a surfactant, such as DOSS, is released from the halloysite nanotubes into the dodecane phase may be characterized with pendant drop tensiometry. Curve A of FIG. 14 depicts the dynamic interfacial tension measurements of the halloysite nanotubes with no surfactant loaded to the halloysite nanotubes. It may be appreciated that without surfactant loading into the halloysite nanotubes, there is no significant reduction in interfacial tension. However, for the surfactant-loaded halloysite nanotube samples, as illustrated in curves A and B of FIG. 14, the release of surfactant molecules from halloysite nanotubes into the dodecane phase results in a dynamic reduction in the dodecane-saline water interfacial tension.

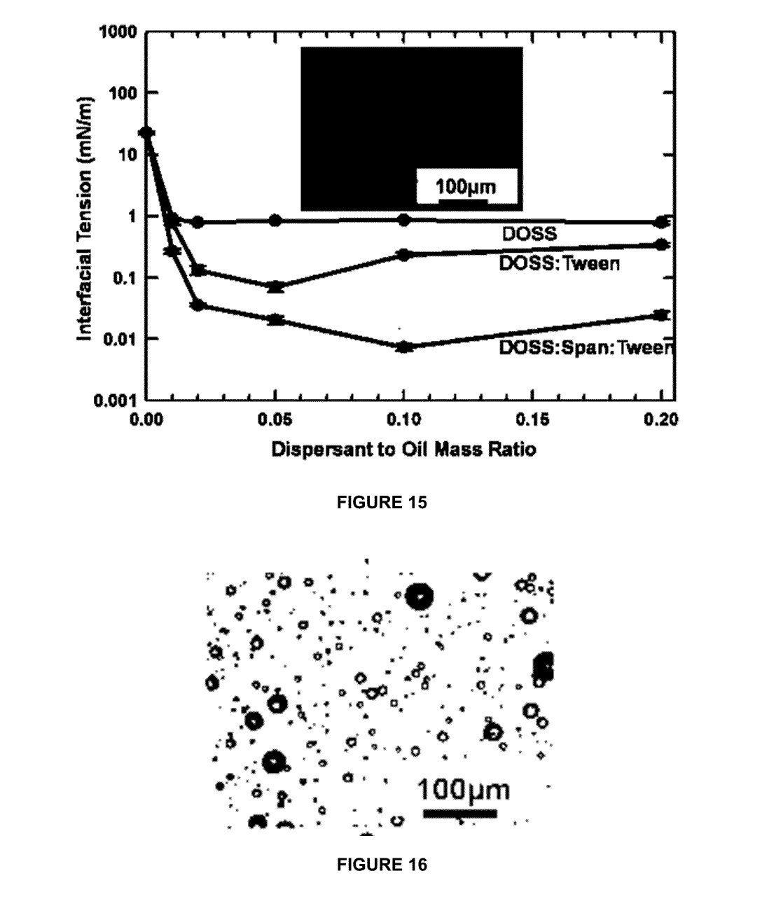

It may be appreciated that the ability of dispersants to significantly lower the crude-oil water interfacial tension, as demonstrated above, is an important criterion in effectively dispersing spill oils. Synergism in mixtures of surfactants can reduce the interfacial tension to levels appropriate for the dispersions of spills oils. When surfactants act in synergy, the interfacial tension can be reduced beyond the level obtainable with the individual surfactants. For example, blends of surfactants such as DOSS, Tween 80, and Span 80 are commonly used in dispersant formulation. Recently, the correlation between effectiveness of dispersants containing DOSS, Tween 80, and Span 80 to the initial and dynamic oil-water interfacial tension was disclosed by Reihm and McCormick in “The Role of Dispersants” Dynamic Interfacial Tension in Effective Crude Oil,” Marine Pollution Bulletin 84 (2014), expanding on an earlier work by Brochu disclosed in “Dispersion of Crude Oil in Seawater: The Role of Synthetic Surfactants,” Oil Chem. Pollut. The publications disclosed that DOSS helps stabilize the interface formed during the breakup of dispersant-treated oil, which Tween 80 and Span 80 allow formation and retention of low interfacial tensions. A testing of the combined effects of the three surfactants used in the formulation of COREXIT 9500 is also disclosed, with the results depicted in FIG. 15. Halloysite nanotubes may be loaded with one or more combinations of DOSS, Tween 80, and Span 80. As depicted in FIG. 15, the crude-oil saline water interfacial tension values may be obtained at various dispersant-to-oil mass ratios. The dispersants may be halloysite nanotubes loaded with DOSS; a binary mixture of DOSS and Tween 80, at a ratio of 80:20; and a ternary mixture of DOSS, Tween 80, and Span 80, at a ratio of 48:32:20. Methanol may be used as the solvent for the surfactants to infiltrate the halloysite lumen. The surfactant compositions may be chosen to span the three levels of interfacial tension reduction effectiveness for blends of DOSS, Tween 80, and Span 80. The release of surfactant cargo from halloysite nanotubes lowers the crude oil-saline water interfacial tension to levels appropriate for the dispersion of spill oils. An optical micrograph of crude oil-in-saline water emulsion, stabilized by halloysite nanotubes loaded with a ternary mixture of DOSS, Tween 80, and Span 80, is depicted in FIG. 16, at a dispersant-to-oil ratio of 1:10. It may be noted that the crude oil-saline water interfacial tension is significantly reduced with the dry surfactant-loaded halloysite nanotube dispersants without the use of hydrocarbon solvents. Accordingly, the low-cost, ready availability, biocompatibility, low cytotoxicity, and interfacial activity of halloysite nanotubes as disclosed herein provide a more efficient and environmentally friendly solution to the problem of oil spill remediation.

While certain novel features of this invention, shown and described above, are pointed out in the appended claims, the invention is not intended to be limited to the details specified. A person of ordinary skill in the relevant art will understand that various omissions, modifications, substitutions, and changes in the forms and details of the invention illustrated and in its operation may be made without departing in any way from the spirit of the present invention. The rights to the present invention are to be limited only by the scope of the appended claims

I claim:

1. A composition of matter, comprising:
(i) an aluminosilicate compound with a tubular morphology, wherein said aluminosilicate compound features a positively-charged inner lumen and a negatively-charged outer lumen; and
(ii) one or more nanoscale zerovalent iron particles encapsulated within said aluminosilicate compound.

2. The composition of claim 1, wherein said aluminosilicate compound is halloysite.

3. A method of creating a composition of matter, comprising:
(i) procuring an aluminosilicate compound with a tubular morphology in powdered form, wherein said aluminosilicate compound features a positively-charged inner lumen and a negatively-charged outer lumen;
(ii) allowing a solution of metal salts to fall dropwise over said aluminosilicate compound;
(iii) imbibing said aluminosilicate compound with said solution via capillary techniques;
(iv) adding a surfactant and/or polymers to enhance the transport characteristics of the composition of matter;
(v) drying said aluminosilicate compound;
(vi) contacting said dried aluminosilicate compound with 0.8M NaBH₄; and
(vii) transforming metal salts into zerovalent iron nanoparticles.

4. The method of claim 3, further comprising contacting said composition of matter with a substance containing chlorinated hydrocarbons, for the purpose of remediating said chlorinated hydrocarbons.

5. The method of claim 4, wherein said aluminosilicate compound is halloysite.

6. The method of claim 4, wherein said composition of matter adsorb said chlorinated hydrocarbons.

7. The method of claim 4, further comprising a polyelectrolyte in which said aluminosilicate compound is enveloped.

8. The method of claim 4, wherein said metal salts are FeSO₄ or FeCl₃.

9. A method of creating a composition of matter, comprising:
(i) procuring an aluminosilicate compound with a tubular morphology in powdered form, wherein said aluminosilicate compound features a positively-charged inner lumen and a negatively-charged outer lumen;
(ii) allowing a solution of metal salts to fall dropwise over said aluminosilicate compound;
(iii) imbibing said aluminosilicate compound with said solution via capillary techniques;
(iv) adding a surfactant and/or polymers to enhance the transport characteristics of the composition of matter; and
(v) heating said iron salt-loaded aluminosilicate compound in a high-temperature furnace under a hydrogen atmosphere or a mixed hydrogen/nitrogen atmosphere for a sufficient period of time to transform said iron species within said aluminosilicate compound to zerovalent iron nanoparticles.

10. The method of claim 9, further comprising contacting said composition of matter with a substance containing chlorinated hydrocarbons, for the purpose of remediating said chlorinated hydrocarbons.

11. The method of claim 10, wherein said aluminosilicate compound is halloysite.

12. The method of claim 10, further comprising a polyelectrolyte in which said aluminosilicate compound is enveloped.

13. A composition of matter, comprising:
(i) an aluminosilicate compound with a tubular morphology, wherein said aluminosilicate compound features a positively-charged inner lumen and a negatively-charged outer lumen; and
(ii) one or more dispersants encapsulated within an inner lumen and interlayers of said aluminosilicate compound.

14. The composition of claim 13, wherein said aluminosilicate compound is halloysite.

15. A method of creating a composition of matter, comprising:
(i) procuring an amount of an aluminosilicate compound with a tubular morphology, wherein said aluminosilicate compound features a positively-charged inner lumen and a negatively-charged outer lumen;
(ii) dissolving a surfactant in methanol;
(iii) adding said dissolved surfactant to a chamber containing said aluminosilicate compound;
(iv) dispersing said aluminosilicate compound by magnetic stirring and ultrasonication;
(v) applying vacuum suction to the contents of said chamber containing said aluminosilicate compound and said dissolved surfactant;
(vi) allowing the pressure to cycle back to atmospheric pressure;
(vii) evaporating any remaining said methanol; and
(viii) allowing said dissolved surfactant to crystallize inside said aluminosilicate compound.

16. The method of claim 15, further comprising:
(ix) deploying an effective amount of said composition on an oil phase on the surface of a body of water;
(x) dispersing said oil phase into smaller droplets; and
(xi) degrading said droplets of oil with agitation of the water surface, bacteria, and microbes,
for the purpose of remediating oil.

17. The method of claim 16, wherein said aluminosilicate compound is halloysite.

18. The method of claim 15, further comprising:
(ix) pulverizing said composition into a powder, granules, or a slurry; and
(x) spraying an oil phase with said powder, granules, or slurry,
for the purpose of remediating said oil phase.

19. The method of claim 15, wherein said aluminosilicate compound is halloysite.

20. The method of claim 18, wherein said spraying is directed at an oil phase on the surface of a body of water from an aircraft or boat, or through direct injection to an oil phase under the surface of a body of water.
